(19) United States
(12) Patent Application Publication
(10) Pub. No.: US 2018/0213948 A1
(43) Pub. Date: Aug. 2, 2018

(54) OIL BUCKET STORAGE AND DISPENSING RACK

(71) Applicant: Englefield, Inc., Heath, OH (US)

(72) Inventor: Gale L. Amacher, JR., Granville, OH (US)

(21) Appl. No.: 15/418,957

(22) Filed: Jan. 30, 2017

(51) Int. Cl. A47F 7/28; A47F 1/12; A47F 5/00; B67D 7/04; B67D 7/84; B65D 1/16; B65D 25/54; B65D 25/32; B65D 47/20; B65D 47/06

(52) U.S. Cl. CPC A47F 7/288; A47F 1/12; A47F 5/0025; B67D 7/04; B65D 47/06; B65D 1/16; B65D 25/54; B65D 25/32; B65D 47/20; B67D 7/84

(57) ABSTRACT

A system for storing and dispensing oil or other fluid. An upper shelf is configured to receive at least one oil bucket in a lateral position while a lower shelf is configured to receive at least one dispensing container. In an exemplary embodiment, each oil bucket has a transparent or translucent body and a dispensing mechanism that provides a flow path through a cap, and each dispensing container has an aperture for receiving oil from the oil bucket. A leading edge of the lower shelf protrudes beyond a leading edge of the upper shelf such that the aperture in the dispensing container may be positioned below the dispensing mechanism in the oil bucket.

### CROSS-REFERENCE TO RELATED APPLICATION

This application makes no priority claim.

### TECHNICAL FIELD

Exemplary embodiments of the present invention relate generally to an apparatus and system for storing and dispensing liquids, such as oil.

### BACKGROUND AND SUMMARY OF THE INVENTION

Automotive shops use a significant quantity of oil and other liquids when performing services, such as oil changes. These automotive shops typically order oil in bulk where the oil is shipped in large size containers so as to lower the cost of shipping, packaging, handling, and the like. For example, bulk oil sometimes comes in large containers, such as five gallon containers. However, these large containers are cumbersome and difficult to use when dispensing oil into a vehicle or other machine. Therefore, the automotive shops often redistribute the oil from the large containers into smaller containers designed to facilitate the dispensing of oil into the vehicle. However, this redistribution process can be time consuming and difficult, sometimes leading to spillages, waste, or injury. Further, different oil weights and viscosities are sometimes required for different vehicles. Even within a particular oil weight and viscosity, different types of oils are sometimes used for different vehicles based on requirements or customer preferences, such as conventional, synthetic blend, and full synthetic oils. Each weight, viscosity, and type needs to be kept in stock to service different vehicles based on vehicle requirements or customer preferences, further compounding the complexity of storage and redistribution.

One known system for storing and distributing oil utilizes a storage rack configured to hold boxes of oil. Such boxes are typically made of cardboard with an internal bladder to contain the oil. As a result, a user cannot see how much oil is in the box. Furthermore, the use of such boxes with a storage rack can make the system top heavy and thus unstable and difficult to manage. Therefore, a need exists for an improved system and method for storing and dispensing oil or other fluids.

An exemplary embodiment of the present invention is an apparatus and system for storing and dispensing buckets of oil or other fluids. In an exemplary embodiment, oil bucket(s) are placed on a downwardly sloping upper shelf of a rack and may be cradled and held in place by a guard and/or side bracket(s). An example of an oil bucket may be comprised of a transparent or translucent body with a cap overtop of the body and a dispensing device that protrudes or otherwise provides a flow path through said cap. The upper shelf may have at least one cut-out in the guard that is sized and configured to accommodate the dispensing device of an oil bucket. A lower shelf may be located below the upper shelf. A leading edge of the lower shelf may protrude beyond a leading edge of the upper shelf. Dispensing containers may comprise an aperture (e.g., on a top) and may be placed on the lower shelf such that the aperture of each dispensing container is located below the dispensing device of the respective oil bucket. In an exemplary embodiment, a second set of upper and lower shelves may be located below the aforementioned upper and lower shelves. Other embodiments may comprise any number of upper and lower shelf pairings.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features.

FIG. 1A is front perspective view of an exemplary system in accordance with the present invention.

FIG. 1B is another front perspective view of the system of FIG. 1.

FIG. 2A is a detailed side view of an exemplary oil bucket in use with the system of FIG. 1.

FIG. 2B is a detailed rear view of the exemplary oil buckets in use with the system of FIG. 1.

FIG. 3 is a front view of the system of FIG. 1.

FIG. 4 is a detailed side perspective view of the system of FIG. 1.

FIG. 5 is a detailed front view of the system of FIG. 1.

FIG. 6 is a detailed front perspective view of the system of FIG. 1, wherein a user is dispensing oil from a bucket.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

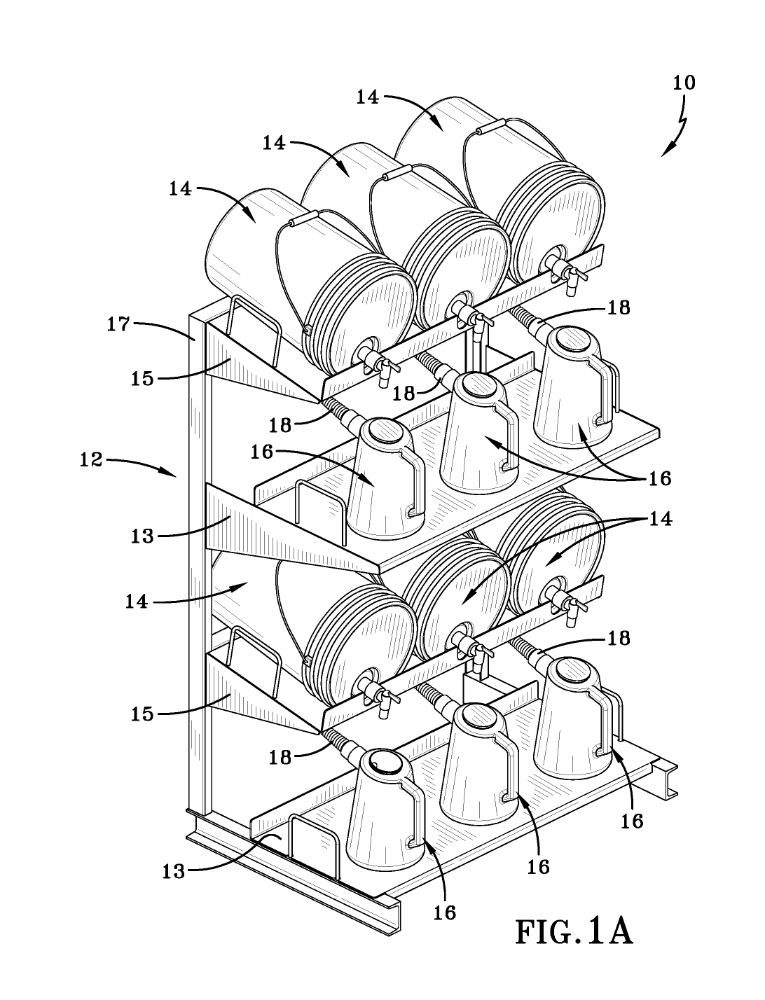

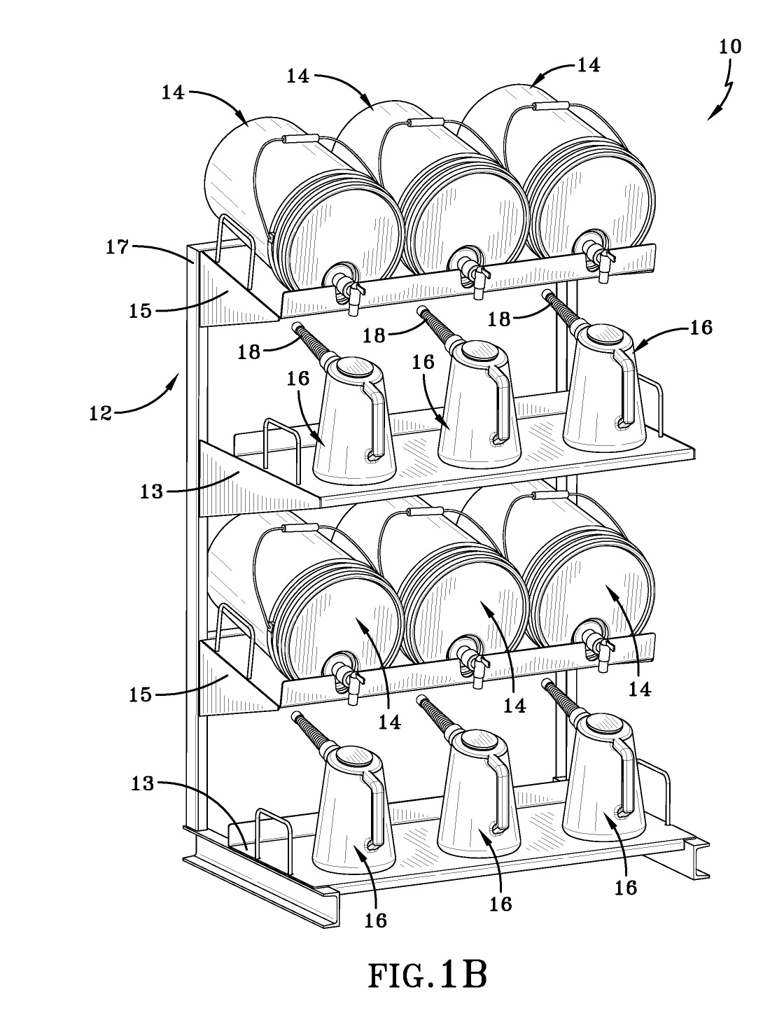

FIGS. 1A and 1B are front perspective views of an exemplary system 10 in accordance with the present invention. The system 10 may comprise a storage rack 12, which may be configured to hold at least one oil bucket 14 (e.g., a series) and at least one dispensing container 16 (e.g., a series) on separate, alternating shelves of the storage rack 12. The oil bucket(s) 14 may be placed on an upper shelf 15, while the dispensing container(s) 16 may be placed on a separate, lower shelf 13 located below the upper shelf 15. In exemplary embodiments of the present invention, the upper shelf 15 may be configured to receive the oil buckets 14 in a lateral position, such that the oil buckets 14 rest on the sidewalls of the body 20. The lower shelf 13 may be configured to receive said dispensing containers 16 in an upright position such that the dispensing containers 16 rest on their bottom surface. In other exemplary embodiments, a dispensing container may rest on a shelf in any suitable position that allows it to receive oil from a bucket on the upper shelf.

An upper shelf 15 and a lower shelf 13 may be bonded, adhered, fastened, or otherwise connected to a frame 17 such that the upper shelf 15 and the lower shelf 13 are spaced apart vertically from one another. In exemplary embodiments of the present invention, the frame 17 may be rectangular in shape, though any shape is contemplated. Any number, size, or shape framing members may be utilized. Any number, size, or shape support members may also be utilized and may connect or extend across various parts of the frame or shelves to provide structural stability, strength, support, or rigidity. An example of the storage rack 12 may be comprised of metal, though any material is contemplated. For purposes that will explained in greater detail herein, a leading edge of the lower shelf 13 may protrude beyond a leading edge of the upper shelf 15; an upper shelf 15 may be angled downward such that an oil bucket 14 is received in a lateral position but also sloped at a downward angle; and a lower shelf 13 may be substantially parallel with the ground or otherwise level such that a dispensing container 16 may be held in a substantially level position.

In exemplary embodiments of the present invention, the storage rack 12 may comprise a pair of upper shelves 15 and a pair of lower shelves 13 stacked vertically such that a first upper shelf 15 is positioned above a first lower shelf 13, which is positioned above a second upper shelf 15, which is positioned above a second lower shelf 13. However, it is contemplated that a storage rack 12 may comprise any number of these upper and lower shelf parings 15 and 13 for any number of rows or vertical arrangements (e.g., columns) of oil buckets 14 and dispensing containers 16.

The shelves, including but not limited to the pair of upper shelves 15 and the pair of lower shelves 13, may be vertically and/or horizontally adjustable. For example, but not to serve as a limitation, the shelves may comprise one or more grooves or protrusions configured to be selectively secured within one or more corresponding slots or projections in the storage rack 12. As another example, but not to serve as a limitation, rollers or sliders may be used to permit horizontal or vertical movement of the shelves. These are merely examples and are not intended to be limiting. Any mechanism or technique may be used to achieve adjustability of the shelves, and the shelves may be independently adjustable or adjustable in any grouping. In one exemplary embodiment of the present invention, the lowest shelf may be adjustable horizontally, while the upper three shelves may be adjustable vertically.

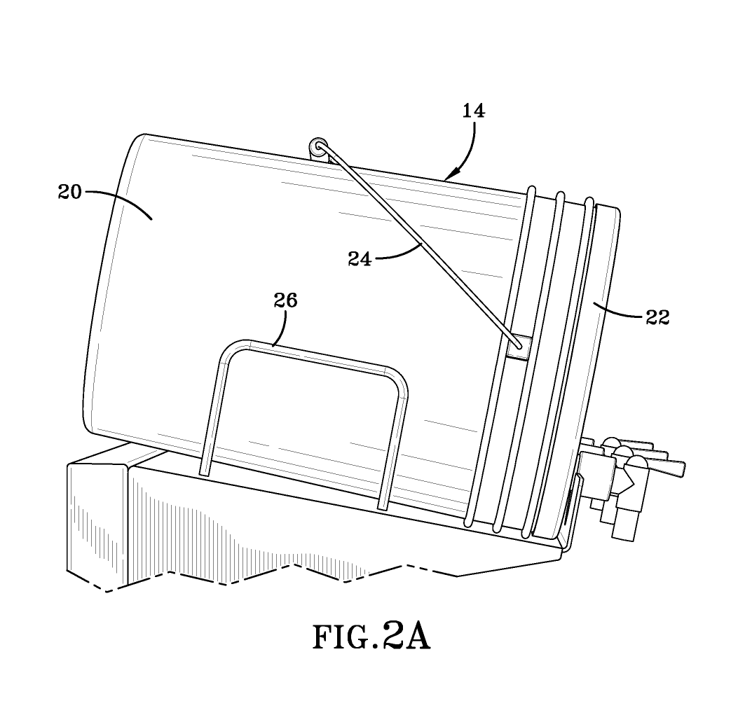

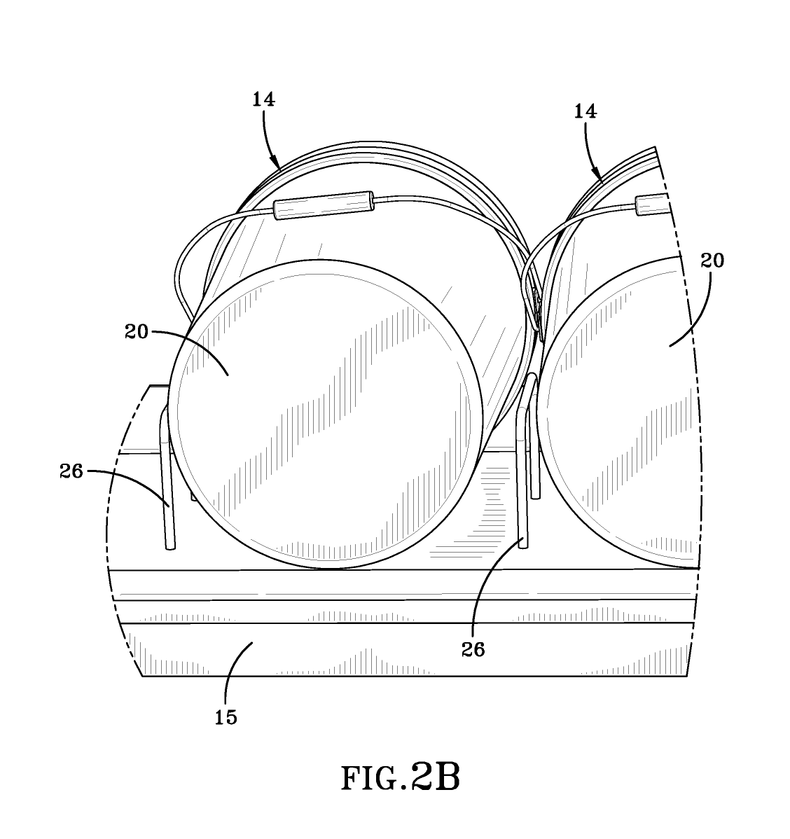

In the example shown in FIGS. 2A and 2B, each shelf of the storage rack 12, including an upper shelf 15 and a lower shelf 13, may comprise side brackets 26 located on either end of each of the shelves. Such as shown in FIG. 2B, the side brackets 26 may also be located between the oil buckets 14 or the dispensing containers 16. The side brackets 26 may be located and configured to secure the oil buckets 14 and the dispensing containers 16 on their respective shelves. Other exemplary embodiments may include any number and location of side brackets 26.

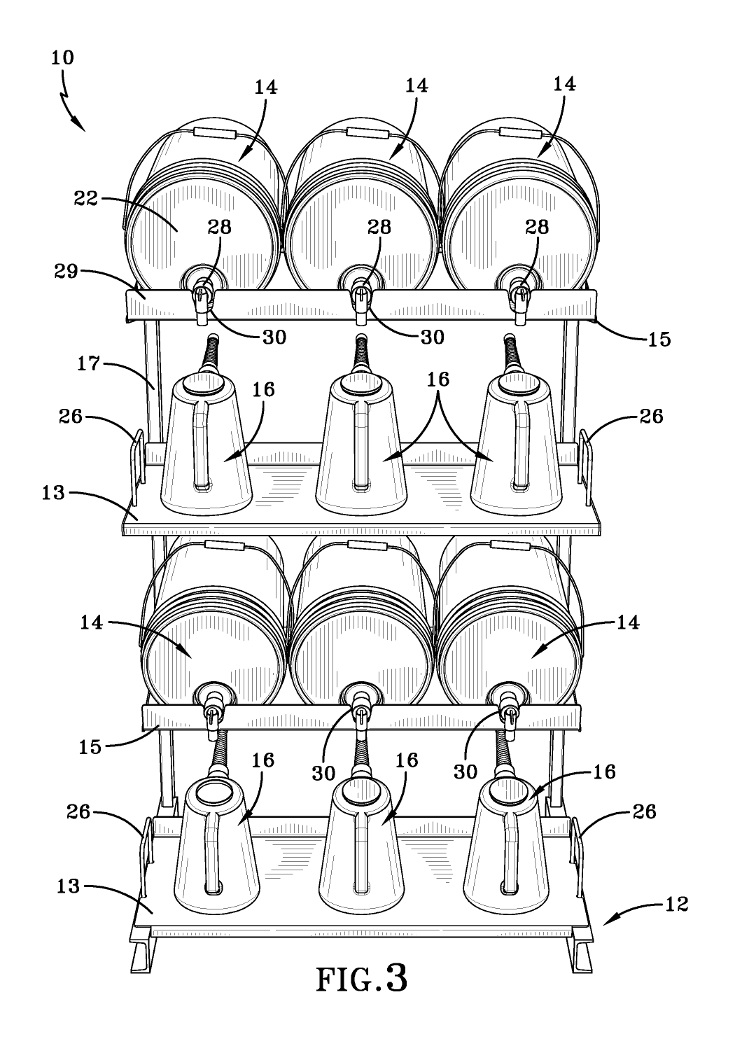

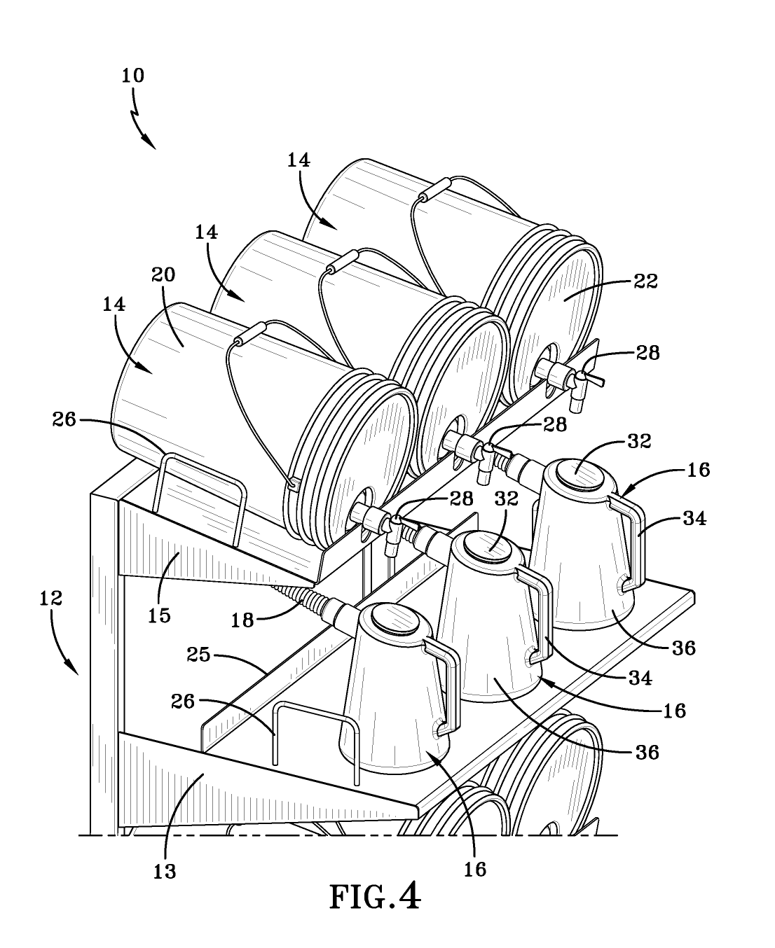

FIGS. 3 and 4 provide additional views of a system 10. A leading edge of the upper shelf 15 may comprise a guard 29 which extends across the leading edge so as to prevent the oil bucket(s) 14 from traveling therebeyond, even if the upper shelf 15 is angled downward. The guard 29 may comprise at least one cut-out 30 located therein, wherein each cut-out 30 may be configured to accommodate one of the dispensing mechanisms 28. A cut-out 30 may alternatively be an aperture, depression, or the like. In an exemplary embodiment, the cut-outs 30 may be positioned such that the oil buckets 14 are substantially evenly spaced across the upper shelf 15. In this way, when the dispensing containers 16 are aligned below the oil buckets 14, the dispensing containers 16 may likewise be substantially evenly spaced. Other exemplary embodiments may implement other spacing.

In order to facilitate alignment of a dispensing container 16 with a dispensing mechanism 28, a leading edge of a lower shelf 13 may protrude beyond a leading edge of an upper shelf 15 such as shown in FIG. 4. As a result, a dispensing container 16 may be positioned on a lower shelf 13 such that a dispensing mechanism 28 of an oil bucket 14 is substantially directly above a lid 32 of a dispensing container 16 to facilitate pouring. In an exemplary embodiment, a lower shelf 13 may also comprise a rear lip 25 configured to prevent a dispensing container 16 from traveling therebeyond and spilling when the dispensing container 16 is on the lower shelf 13.

In an exemplary embodiment of the present invention, the upper shelf 15 may be sized and configured to accommodate three oil buckets 14, though it is contemplated that any number of oil buckets 14 may be utilized and the upper shelf 15 may be sized and configured accordingly. Likewise, the lower shelf 13 may be sized and configured to accommodate three dispensing containers 16, though it is also contemplated that any number of dispensing containers 16 may be utilized and the lower shelf 13 may be sized and configured accordingly. Preferably, the number of dispensing containers 16 is equal to the number of oil buckets 14, though such is not required.

FIG. 2A and FIG. 2B also provide a detailed side and rear view, respectively, of an exemplary oil bucket 14 for use with the system 10. In exemplary embodiments of the present invention, the oil buckets 14 are five gallon buckets, though any size bucket is contemplated. The storage rack 12 may be likewise sized to accommodate different sized oil buckets 14. Regardless, the oil buckets 14 and various components thereof may be comprised of a plastic, though any material is contemplated.

An example of an oil bucket 14 may comprise a body 20 and a cap 22 located over an opening of the body 20 (e.g., over a top or other suitable portion of a body or bucket) and configured to substantially seal the oil bucket 14. In exemplary embodiments of the present invention such as shown in FIGS. 2A and 2B, the body 20 may be comprised of a transparent or translucent material such that a level of the oil stored therein may be seen from the outside. This may also include the bottom surface of the body 20 (e.g., FIG. 2B) and/or the cap 22 such that the oil level may be viewed when the oil buckets 14 are stored laterally on an upper shelf 15. As a result, a user is readily able to determine when a bucket is low or empty and needs or soon needs to be replaced. An example of an oil bucket 14 may further comprise a handle 24, grip, or other mechanism to facilitate handling.

Such as referenced earlier with respect to FIGS. 3 and 4, each oil bucket 14 may comprise a dispensing mechanism 28. In exemplary embodiments of the present invention, the dispensing mechanism 28 is a tap which protrudes or otherwise provides a flow path through the cap 22 of the oil bucket 14. While such an embodiment is advantageous, other exemplary embodiments of a dispensing mechanism may be located at any other suitable position on a bucket or other container, unless otherwise specified. In addition, other exemplary embodiments may utilize other suitable types of dispensing mechanisms, including but not limited to spouts, etc., unless otherwise specified.

While the aforementioned embodiment of a bucket provides significant advantages, other buckets having different shapes or configurations may be utilized with some other exemplary embodiments of the present invention, unless otherwise specified. Likewise, unless otherwise specified, other types of containers, which are preferably but not necessarily transparent or translucent, may be utilized with some other exemplary embodiments of the present invention.

An example of dispensing container 16 is shown in FIG. 4. In this embodiment, each dispensing container 16 may comprise a container body 36, a handle 34, a lid 32, and a spout 18. In exemplary embodiments of the present invention, the container body 36 is hollow and configured to hold a quantity of the oil. An example of the handle 34 may be configured to extend from the container body 36 and may likewise be hollow and configured to hold a small portion of the oil. In another embodiment, a handle may be formed in the body or may otherwise not be hollow. The lid 32 is preferably located on the top of the container body 36. However, in other exemplary embodiments, a lid may be located on any other suitable portion of a body or container. Removal of the lid 32 may give access to the interior of the container body 36 via an aperture located thereunder. The lid 32 may be secured to the container body 36 by threads, snaps, or any other attachment mechanism. The spout 18 may extend from a front surface of the container body 36, preferably near the top thereof to facilitate pouring. In particular, the spout 18 may be an elongated hollow tube such that oil may be dispensed from the container body 36, through the spout 18, and into a vehicle or other machine when the container body 36 is tilted forward. In other exemplary embodiments of the present invention, the dispensing container 16 may not use a spout 18, may have a spout at another location, or may otherwise have another configuration to facilitate dispensing of the contents. At least a portion of the container body 36 (or other portion of the container) may be translucent or transparent and may comprise graduated markings such that the amount of oil in the dispensing container 16 may be measured. These markings may be used to determine how much oil has been dispensed from an oil bucket 14 into a dispensing container 16 and from a dispensing container 16 into a vehicle or other machine.

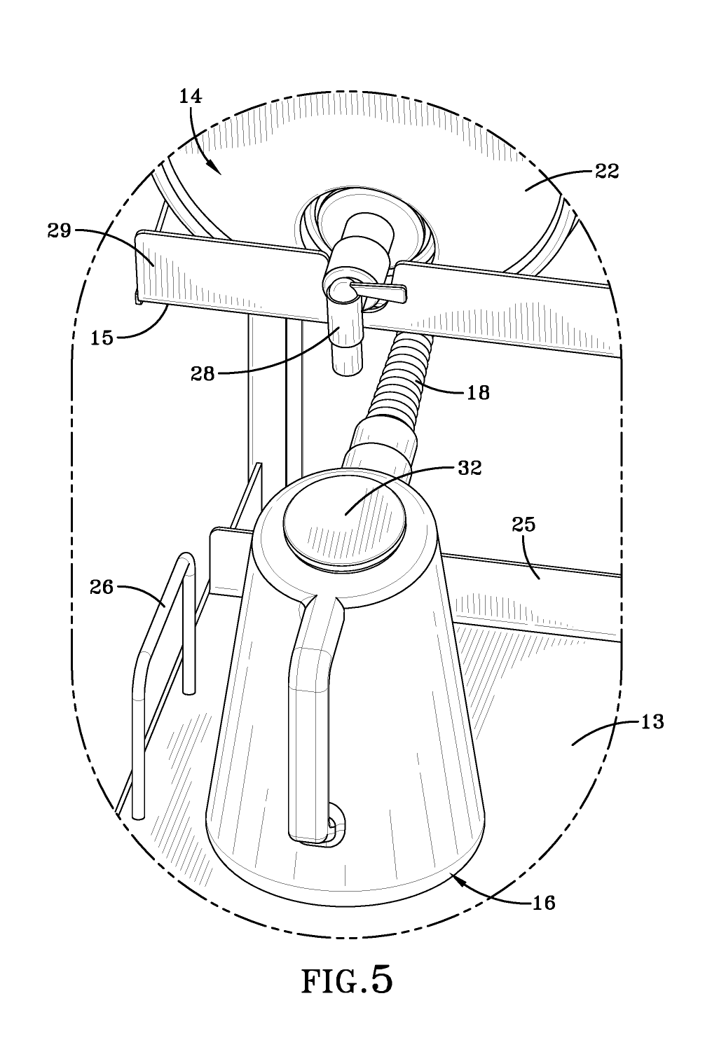

FIG. 5 is a detailed front view of the system of FIG. 1 further illustrating how the dispensing mechanism 28 of the oil bucket 14 may be placed substantially directly above the lid 32 of the dispensing container 16. In exemplary embodiments, the lid 32, and the aperture located thereunder, may be larger than the stream of oil from the dispensing mechanism 28 to facilitate receipt of the contents of the bucket. Any size lid 32 and corresponding aperture is contemplated.

Due to the alignment of a dispensing container 16 with a dispensing mechanism 28, a lid 32 may simply be removed and the dispensing mechanism 28 may be operated to dispense an amount of oil from the oil bucket 14 into the dispensing container 16. Once filled to a desired level, the dispensing mechanism 28 may be shut off, and the lid 32 may be replaced. The dispensing container 16 may then be easily removed from the shelf for use, such as to dispense the oil contained therein into one or more vehicles or other machines.

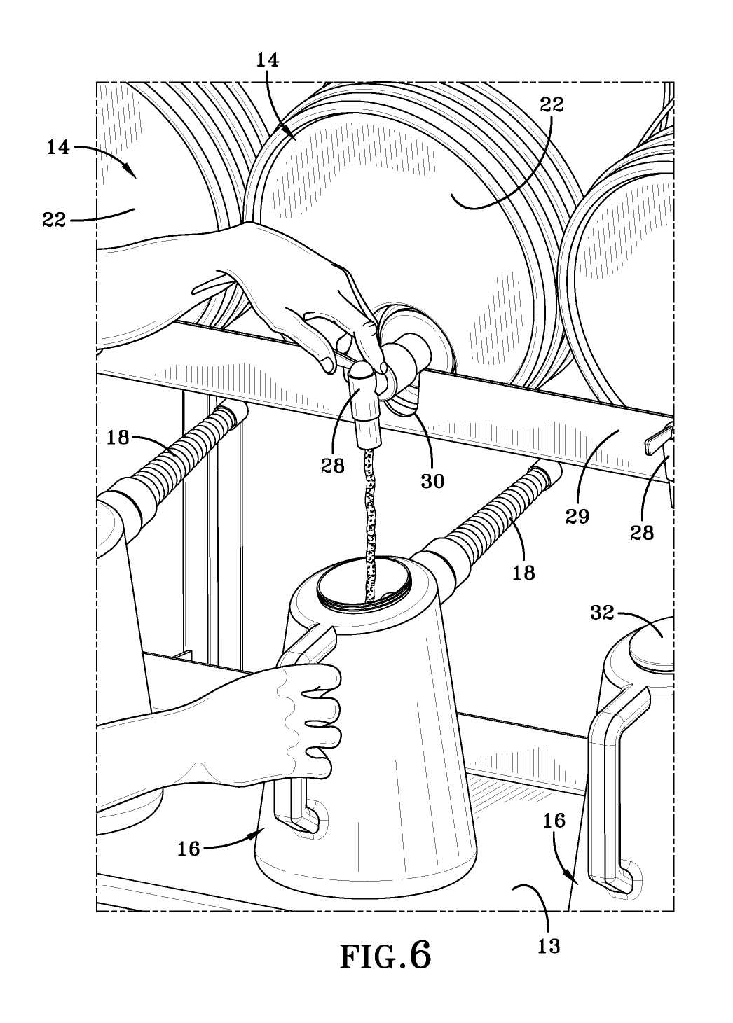

FIG. 6 shows an example of oil being dispensed from an oil bucket 14 into a dispensing container 16. To summarize, in exemplary embodiments of the present invention, this process may include the steps of placing the oil bucket 14 on the upper shelf 15 and placing the dispensing container 16 on the lower shelf 13 below the oil bucket 14. The cap 32 is removed from the dispensing container 16, and the dispensing mechanism 28 is operated to dispense a desired amount of oil or other contents into dispensing container 16. In exemplary embodiments of the present invention, the dispensing mechanism 28 may be operated by manipulating a tap. After a desired amount has been dispensed, the cap 32 may be replaced, and the dispensing container 16 may be removed from lower shelf 13. The dispensing container 16 may then, for example, be taken to a vehicle, and oil may be dispensed through the spout 18 into the vehicle.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

1. A system for storing and dispensing oil comprising:
an upper shelf comprising a downward sloping surface configured to receive at least one oil bucket that has a dispensing mechanism positioned on an end thereof, said upper shelf configured to receive said at least one oil bucket in a lateral position such that a side surface of the oil bucket is configured to rest on the downward sloping surface; and
a lower shelf positioned below said upper shelf and configured to receive at least one dispensing container that has an aperture located thereon, said lower shelf configured to receive said at least one dispensing container in an upright position;
wherein a leading edge of said lower shelf protrudes beyond a leading edge of said upper shelf such that the aperture of a respective said dispensing container is adapted to be positioned below the dispensing mechanism of a respective said oil bucket to facilitate dispensing of a content of said respective oil bucket into said respective dispensing container.

2. The system of claim 1 wherein said lower shelf is positioned to be adapted to hold said at least one dispensing container in a substantially level position.

3. The system of claim 1 wherein said upper shelf is positioned to be adapted to hold said at least one oil bucket at a downward angle.

4. The system of claim 1 further comprising a guard positioned along the leading edge of said upper shelf configured to prevent a body of a respective said oil bucket from traveling therebeyond.

5. The system of claim 4 further comprising at least one cut-out in said guard configured to receive the dispensing mechanism of a respective said oil bucket.

6. The system of claim 1 further comprising a lip positioned along a rear edge of said lower shelf configured to prevent said at least one dispensing container from traveling therebeyond when said at least one dispensing container is placed on said lower shelf.

7. The system of claim 1 further comprising a plurality of side brackets respectively positioned on side edges of said upper shelf and said lower shelf.

8. The system of claim 1 wherein:
said upper shelf is adapted to hold three of said oil buckets; and
said lower shelf is adapted to hold three of said dispensing containers.

9. The system of claim 1 further comprising:
a second upper shelf configured to receive at least one oil bucket; and
a second lower shelf configured to receive at least one dispensing container;
wherein said second upper shelf is positioned below said lower shelf and above said second lower shelf; and
wherein a leading edge of said second lower shelf protrudes beyond a leading edge of said second upper shelf.

10. A system for storing and dispensing oil comprising:
at least one oil bucket, each said oil bucket configured to hold oil and comprising a substantially cylindrical body, a cap positioned to substantially seal said body, and a dispensing mechanism that provides a flow path through said cap;
at least one dispensing container, each said dispensing container configured to receive oil through an aperture located thereon;
a storage rack comprising:
a frame;
an upper shelf connected to said frame and comprising a downward sloping surface configured to hold said at least one oil bucket in a lateral position such that the body of the oil bucket is configured to rest on the downward sloping surface and said at least one oil bucket is angled downward; and
a lower shelf connected to said frame below said upper shelf and configured to hold said at least one dispensing container in an upright position;
wherein a leading edge of said upper shelf extends beyond a leading edge of said lower shelf such that the dispensing mechanism of a respective said oil bucket is adapted to be positioned above the aperture in a respective said dispensing container.

11. The system of claim 10 further comprising:
a guard positioned along the leading edge of said upper shelf;
wherein said guard is configured to prevent said at least one oil bucket from traveling therebeyond.

12. The system of claim 11 further comprising at least one cut-out in said guard configured to receive a respective said dispensing mechanism.

13. The system of claim 10 further comprising a lip positioned along a rear edge of said lower shelf configured to prevent said at least one dispensing container from traveling therebeyond.

14. The system of claim 10 further comprising a plurality of side brackets respectively positioned on side edges of said upper shelf and said lower shelf.

15. The system of claim 10 wherein the body of a respective said oil bucket is comprised of a transparent or translucent material such that a level of oil in said respective oil bucket is visible.

16. The system of claim 10 further comprising:
a second upper shelf configured to hold at least one oil bucket; and
a second lower shelf configured to hold at least one dispensing container;
wherein said second upper shelf is positioned below said lower shelf and above said second lower shelf; and
wherein a leading edge of said second lower shelf protrudes beyond a leading edge of said second upper shelf.

17. The system of claim 10 wherein each said oil bucket is transparent or translucent such that a respective level of oil in each said oil bucket is visible.

18. The system of claim 10 wherein each said oil bucket is a five gallon bucket.

19. The system of claim 10 wherein each said dispensing mechanism is a tap.

20. A system for storing and dispensing oil comprising:
a plurality of oil buckets, each said oil bucket configured to hold oil in a transparent or translucent body and further comprising a cap positioned to substantially seal said body, and a dispensing mechanism that provides a flow path through said cap;
a plurality of dispensing containers, each said dispensing container configured to receive oil through an aperture located thereon; and
a storage rack comprising:
a frame;
a first and second upper shelf connected to said frame, each of said first and second upper shelves comprising a downwardly sloped surface for respectively holding at least one of said oil buckets in a downwardly angled lateral position such that the entire body of the oil bucket rests against the downwardly sloped surface; and
a first and second lower shelf connected to said frame, said first lower shelf positioned below said first upper shelf and above said second upper shelf, said second lower shelf positioned below said second upper shelf, each of said first and second lower shelves respectively holding at least one of said dispensing containers in an upright position such that each said aperture is vertically aligned with a respective said dispensing mechanism;
wherein said dispensing mechanism comprises a sprout and a valve.
